(19) United States
(12) Patent Application Publication
(10) Pub. No.: US 2011/0161318 A1
(43) Pub. Date: Jun. 30, 2011

(54) METHOD AND APPARATUS FOR ASSIGNING TAGS TO DIGITAL CONTENT

(75) Inventors: Clifford LYON, Melrose, MA (US); Ned RHINELANDER, Melrose, MA (US)

(73) Assignee: CBS INTERACTIVE INC., San Francisco, CA (US)

(21) Appl. No.: 12/792,029

(22) Filed: Jun. 2, 2010

Related U.S. Application Data
(60) Provisional application No. 61/290,365, filed on Dec. 28, 2009.
(60) Provisional application No. 61/312,032, filed on Mar. 9, 2010.

(51) Int. Cl. G06F 17/30

(52) U.S. Cl. 707/729; 707/E17.084

(57) ABSTRACT

A method and apparatus for assigning topical tags to content on a page stored within a searchable digital document environment is provided. An activity log is created for a document including data indicating search queries resulting in the location of the document by a search engine. Keywords are determined from the activity log, and the document is tagged with a tag associated with the keywords.

### RELATED APPLICATIONS

This application claims the benefit of U.S. Provisional Application No. 61/290,365, filed Dec. 28, 2009, and U.S. Provisional Application No. 61/312,032, filed Mar. 9, 2010, the disclosures of which are hereby incorporated by reference in their entirety.

### TECHNICAL FIELD

The present invention relates to content classification and discovery. More particularly, the present application relates to a method and apparatus for assigning topical tags to digital content.

### BACKGROUND

Most content is now stored in digital format and accessible over networks. For example, Document Management Systems (DMS) provide repositories of documents that can be searched and accessed over a network. Most DMS implementations are within a domain, such as a company, and are used to store documents that can be categorized in a relatively narrow set of topics. For example, a law firm may have legal briefs and other legal documents stored in a DMS. Also, downloadable or streaming media content is available in various domains.

Of course, various repositories of documents and other content can be accessed over the Internet. The most common way of discovering content on the internet is through the use of search engines, which index the content and then provide links to the content in response to keyword or topical search queries. More recently, it has become popular to associate topical or other descriptive tags, from a set of tags, with content to facilitate content discovery and retrieval. The set of tags can be arranged in an ontology or other arrangement and applied to content in a manner which helps describe the content. Of course, the tags facilitate content discovery because indexing of the document is not required and the tags convey a sense of what the content is about in a semantic or topical sense. Ideally, the set of tags associated with a document represent a compressed or minimal description of the document, which serves to both associate the document with its most similar neighbors, and to discriminate it from others unlike it.

However, there are many limitations to developing a set of tags and associating tags with content. For example, different domains may use different sets of tags and tag arrangements. This may cause inconsistencies and even lack of interoperability between domains. Even within a domain with a predetermined tag arrangement, the sheer amount of content makes it difficult to apply tags in a meaningful manner. There are tools for automated tagging. However, such tools are limited and are not effective across broad spectrums of topics and content.

### SUMMARY

Thus, there is a need in the art for a method and apparatus for assigning a topical tag to content on a page stored within a searchable digital document environment. The method includes creating an activity log for a document, said activity log including data indicating search queries resulting in the location of the document by a search engine, determining, from the activity log, at least one keyword in a search query that resulted in location of the document, and tagging the document with a tag associated with the at least one keyword. The apparatus is a computer system programmed with instructions to accomplish these functional steps. The document can be the content to be tagged, or a document related to the content to be tagged. For example, the document can be a document describing video content available for downloading or streaming and which is to be tagged.

Still other aspects, features and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

FIG. 1 is a schematic diagram of a computer system of one embodiment.

FIG. 2 is a schematic representation of a raw document according to one embodiment.

FIG. 3 is a flowchart illustrating a tagging process according to one embodiment.

FIG. 4 is an example of an activity log according to one embodiment.

FIG. 5 is a user interface according to one embodiment.

FIG. 6 is a schematic diagram of a system architecture according to one embodiment.

FIG. 7 is a block diagram of another architecture for implementing the method according to one embodiment.

FIG. 8 is a schematic diagram of an exemplary computer system according to one embodiment.

### DETAILED DESCRIPTION

A method and apparatus for assigning tags to digital content is described. In the following description, for purposes of explanation, numerous specific details are set forth in order to provide a thorough understanding of the exemplary embodiments. It is apparent to one skilled in the art, however, that the present invention can be practiced without these specific details or with an equivalent arrangement. In some instances, well-known structures and devices are shown in block diagram form in order to avoid unnecessarily obscuring the preferred embodiment.

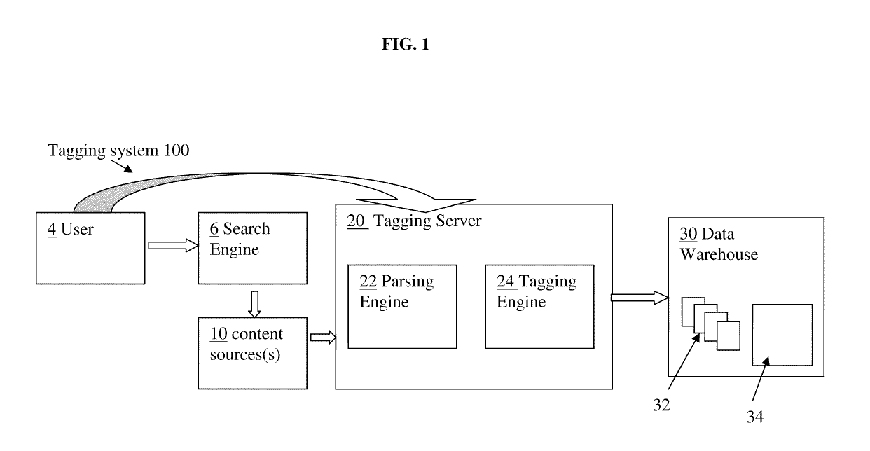

Referring now the drawings, wherein like reference numerals designate identical or corresponding parts throughout the several views, FIG. 1 illustrates an embodiment of a tagging system 100. Tagging system 100 can be based on commercial software products and solutions available from various vendors, such as Hapax Amplify™, Attensity™, Autonomy™, Biz360™, BuzzLogic™, Clarabridge™, IBM™, Infonic™, Inform™, Lexalytics™, TextDigger™, Leximancer™, MotiveQuest™, and RavenPack™. As noted above, automated tagging systems are well known.

Tagging system 100 receives content, processes the content to extract useful information, and provides access to the content for publishing, runtime processing, and analysis. Content can be received from content sources 10 in various ways, such as by being pushed to the tagging system 100 by a remote service, by being imported from a remote source, and/or through crawling the content source. Accordingly, the phrase “receiving content” as used herein means that the content is made accessible directly or indirectly to tagging system 100.

Content sources 10 can be any sources of content such as web sites, RSS feeds, blogs or other user generated content, social networks, catalog data, document management systems or the like. Content from content sources 10 is made available to tagging server 20 through a web crawler sent out by tagging server 20 or other mechanism as noted above. Tagging server 20 has parsing engine 22 which parses and analyzes the content and performs one or more of the following operations: define a notion of a tag, define a notion of term(s), define a notion of a topic, and/or provide an interface for manually introducing defined topics.

Define a notion of a tag. Parsing engine 22 can define a notion of a tag, which has a representation that can semantically describe content, as well as metadata, such as links to other tags, documents or topics, thereby placing the tag in an ontology or other set of tags.

Define a notion of term(s). Parsing engine 22 can define a notion of a term or terms in a document that is useful in describing the document.

Define a notion of a topic. Parsing engine 22 can define a notion of a topic, e.g. a term that is also useful as a category.

Provide an interface for manually introducing defined topics. Parsing engine 22 can provide an interface for permitting manually defined topics to be introduced, allowing editing of topics, terms, and tags, and providing analytical data regarding content and the creation and use of tags and topics.

Tagging engine 24 of tagging server 20 associates tags with documents 32 based on content item, and stores the documents 32 in data warehouse 30. Tag set 34 is also stored in data warehouse 30.

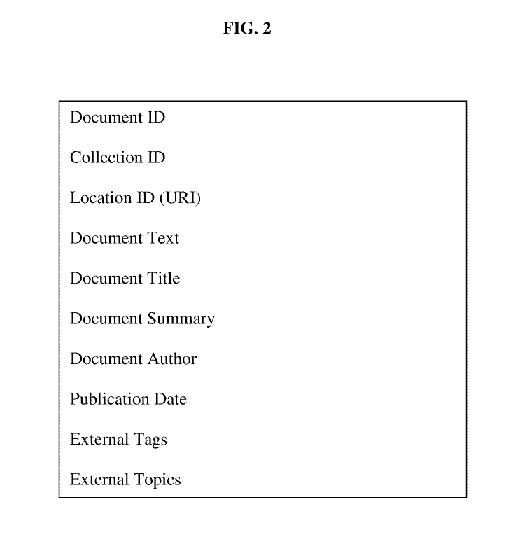

As noted above, documents 32 are an output of parsing engine 22. An example of a document 32 is illustrated in FIG. 2. A document 32 is created for each content item analyzed by tagging system 100 and can include a global sequence unique raw document ID, a collection ID indicating the content source 10 of the content item, a content item location (such as a URL), the text of the content item, the text, title, author publication date etc., of the content item, and a list of tags. The list of tags can potentially be empty and can include tag type, tag identification, and topics. Tags can be assigned subsequently by tagging engine 24.

A user, having user computing device 4, uses provides a query, such as a series of keywords, to search engine 6 in a known manner. Search engine 6 processes the query, to find content items in content sources 10 in a known manner. For example, search engine 6 can use an inverted index of the content items to match the content items to the key words in the query in a known manner.

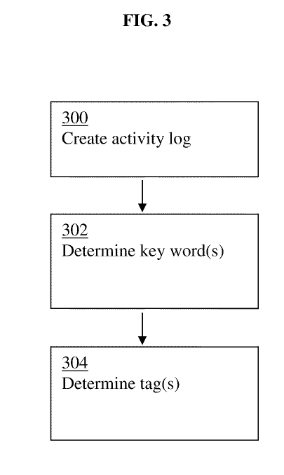

FIG. 3 illustrates the tagging operations of an embodiment. In step 300, an activity log is created for a content item. The activity log can include data relating to search queries resulting in the location of the content item by search engine 6. In step 302, at least one keyword in a search query that resulted in location of the document is determined based on the activity log. In step 304, the document is tagged a tag associated with the at least one keyword. As an example, a query having the keyword DOG might be associated in tag set 34 with the tag CANINE or the tag PET.

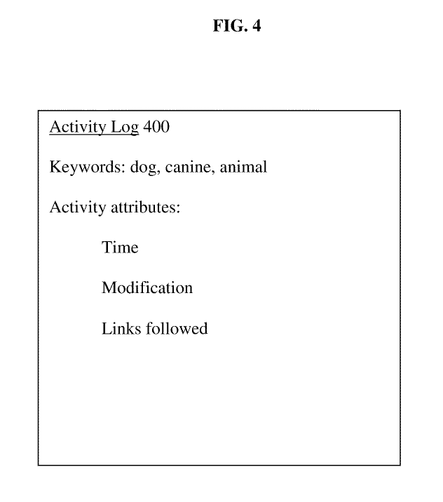

FIG. 4 illustrates an example of an activity log 400 for a content item. The concept of activity logs is well known. The activity log of the embodiment records data about search queries that result in location of the content item. This data can include keywords of the search as well other query data. The activity log 400 can also include document activity attributes, such as the time spent viewing the document as a result of the search, links activated in the content item, edits made to the content item and the like. These attributes can also be used to determine the appropriate tag(s) for the content item. It can be seen that the embodiment leverages user judgment in forming queries and in reviewing documents to ascertain document topics and relevancy.

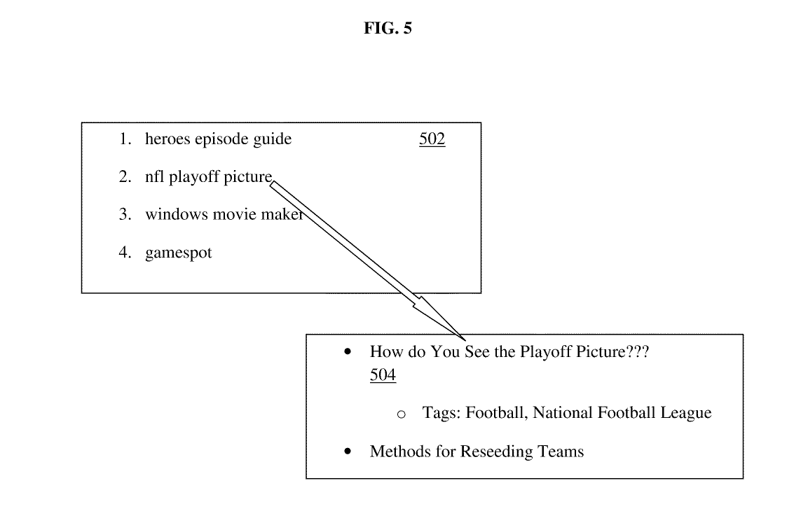

FIG. 5 illustrates the user interface that can be provided as a result of the tagging. In particular, topic page 502 can be presented to users, as a web page displayed in a browser or in any other manner, to provide the user with popular topics or topics based on the user's profile. As an example, selection of the topic “nfl playoff picture” will result in display of article page 504 which shows article titles and tags associated with the articles in the selected topic. The article titles can be linked to the full article.

Tagged content should be organized into topics in order to be presented on topic page 502, and may be created through either a manual or automatic process. Like a tag, a topic is a term, but it may or may not occur in the source document. For example, an article on the television show “CSI” may be assigned to the “television” topic, even if the term “television” doesn't appear explicitly in the document.

The embodiment can provide data and analysis relating to “topic consumption”. New categories can be created based on user interaction with the content. Data and reports of such user interaction can be collected, aggregated, and processed. This can be used to give content owners insight into how the content is being used and monetized across domains and present opportunities for repurposing of content.

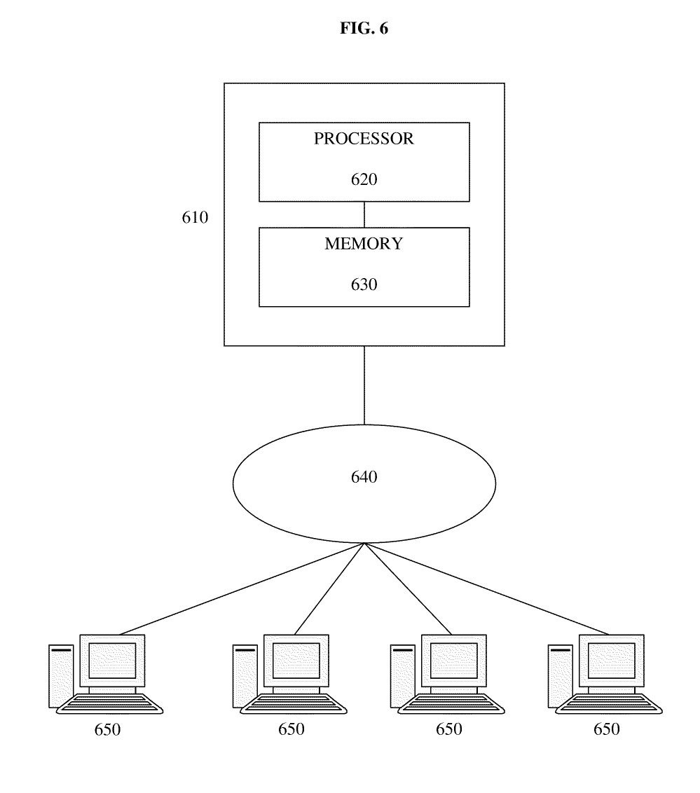

FIG. 6 illustrates a system of an embodiment for effecting the functions described above. Server 610 that is connected over network 640 to a plurality of user systems 650. Server 610 includes processor 620 and memory 630, which are in communication with one another. Server 610 is configured to deliver documents to users at the plurality of user systems 650. Server 610 is typically a computer system, and may be an HTTP (Hypertext Transfer Protocol) server, such as an Apache server. Server 610 may be built using a standard LAMP or other solution stack. Memory 630 may be any type of storage media that may be volatile or non-volatile memory that includes, for example, read-only memory (ROM), random access memory (RAM), magnetic disk storage media, optical storage media, flash memory devices, and zip drives. Network 640 may be a local area network (LAN), wide area network (WAN), a telephone network, such as the Public Switched Telephone Network (PSTN), an intranet, the Internet, or combinations thereof. The plurality of user systems 650 may be mainframes, minicomputers, personal computers, laptops, personal digital assistants (PDAs), cell phones, netbooks, thin clients, and other computing devices. The plurality of user systems 650 are characterized in that they are capable of being connected to network 640. The plurality of user systems 650 typically include web browsers.

In use, when a user of one of the plurality of user systems 650 wants to, for example, search for and navigate to a document as described above, a request to access content is communicated to server 610 over network 640. For example, a signal is transmitted from one of the user systems 650, the signal having a destination address (e.g., address representing the server), a request (e.g., content request), and a return address (e.g., address representing the user system that initiated the request). Processor 620 accesses memory 630 to provide the requested content, which is communicated to the user over network 640. For example, another signal may be transmitted that includes a destination address corresponding to the return address of the client system, and the content responsive to the request.

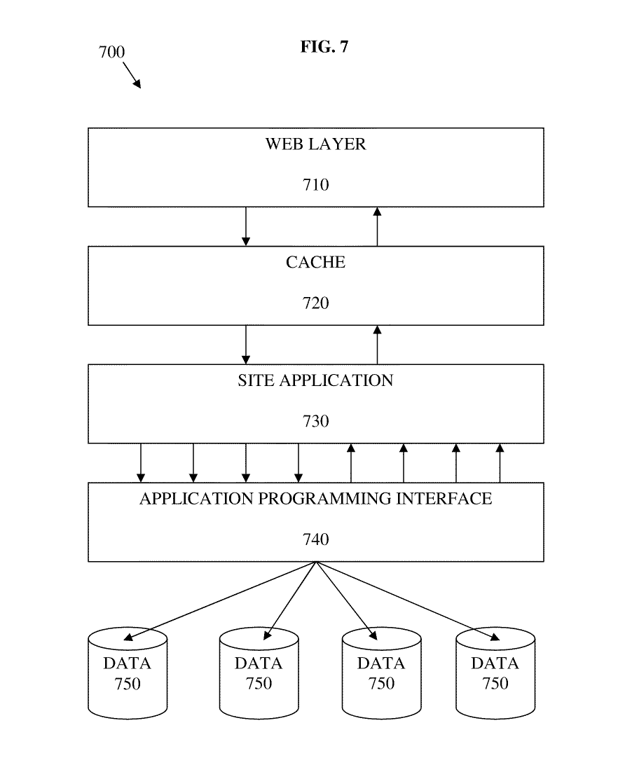

As shown in FIG. 7, system architecture 700 includes web layer 710, cache 720, site application 730, application programming interface 740, and a plurality of data stores 750. It will be appreciated that the system architecture may vary from the illustrated architecture. For example, web layer 710 may directly access data stores 750, the site application may directly access data stores 750, system architecture 700 may not include cache 720, etc., as will be appreciated by those skilled in the art. Web layer 710 is configured to receive user requests, for example, to navigate a document, through a web browser and return content that is responsive to the user request. Web layer 710 communicates the user requests to cache 720. Cache 720 is configured to temporarily store content that is accessed frequently by web layer 710 and can be rapidly accessed by web layer 710. In one embodiment, cache 720 may be a caching proxy server. Cache 720 communicates the user requests to site application 730.

Site application 730 is configured to update cache 720 and to process user requests received from web layer 719. Site application 730 may identify that the user request is for a page that includes data from multiple sources. Site application 730 can then convert the page request into a request for content from multiple sources and transmits these requests to application programming interface 740. Application programming interface 740 is configured to simultaneously access data from the plurality of data stores 750 to collect the data responsive to the plurality of requests from site application 730. The plurality of data stores 750 may include, for example, content items, an activity log, data indicating search queries resulting in the location of a content item, and the like. It will be appreciated that in alternative embodiments only one data store 750 may be provided to store the data.

The data in data stores 750 is provided to application programming interface 740, which provides the content to site application 730. Site application 730 updates cache 720 and delivers the cached content in combination with the accessed content to web layer 710, which delivers browsable content to the user.

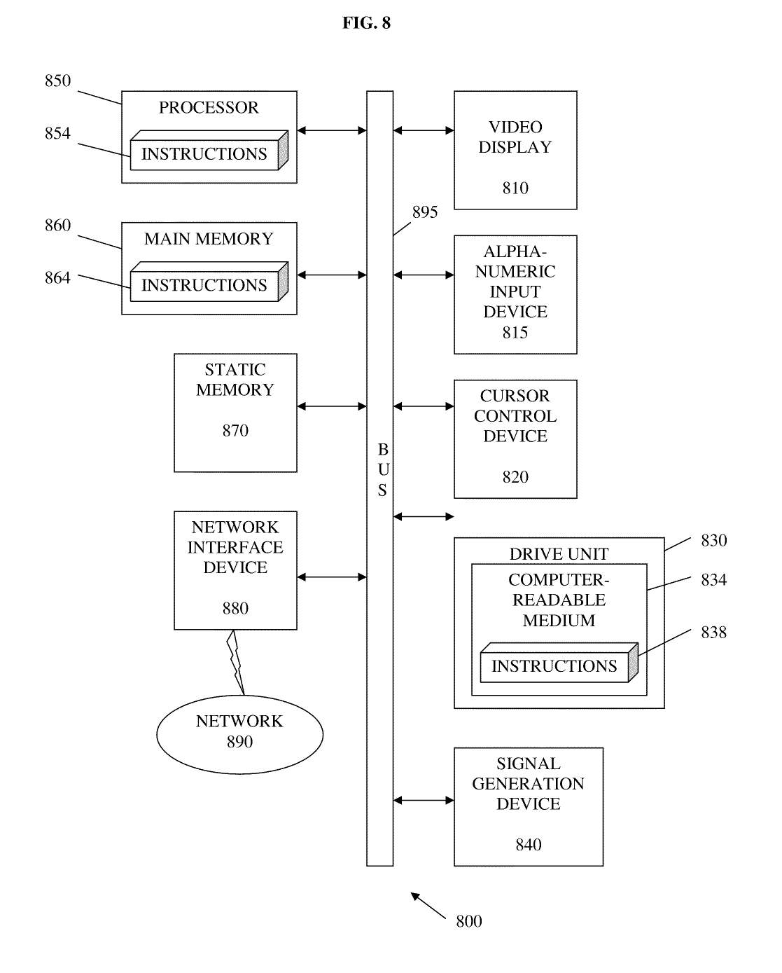

FIG. 8 shows a diagrammatic representation of a machine in the exemplary form of computer system 800 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Computer system 800 includes processor 850 (e.g., a central processing unit (CPU), a graphics processing unit (GPU) or both), main memory 860 (e.g., read only memory (ROM), flash memory, dynamic random access memory (DRAM) such as synchronous DRAM (SDRAM) or Rambus DRAM (RDRAM), etc.) and static memory 870 (e.g., flash memory, static random access memory (SRAM), etc.), which communicate with each other via bus 595.

Computer system 800 may further include video display unit 810 (e.g., a liquid crystal display (LCD) or a cathode ray tube (CRT)). Computer system 800 also includes alphanumeric input device 815 (e.g., a keyboard), cursor control device 820 (e.g., a mouse), disk drive unit 830, signal generation device 840 (e.g., a speaker), and network interface device 880.

Disk drive unit 830 includes computer-readable medium 834 on which is stored one or more sets of instructions (e.g., software 838) embodying any one or more of the methodologies or functions described herein. Software 838 may also reside, completely or at least partially, within main memory 860 and/or within processor 850 during execution thereof by computer system 800, main memory 860 and processor 850 also constituting computer-readable media. Software 838 may further be transmitted or received over network 890 via network interface device 880.

While computer-readable medium 834 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the present invention. The term “computer-readable medium” shall accordingly be taken to include, but not be limited to, solid-state memories, and optical and magnetic media.

The functions of the embodiment can be described as modules of computer executable instructions recorded on tangible media. The modules can be segregated in various manners over various devices.

The invention can be applied to any type of content, such as multimedia content, including video content to be downloaded or streamed.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention.

The invention is achieved by manipulating data structures and transforming the data from one form, useable by a computer for one purpose, to another form, useable by a computer for another purpose.

Other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A method for assigning a topical tag to a content item stored within a searchable digital content item environment, said method comprising:
creating an activity log for a content item, said activity log including data indicating search queries resulting in a location of the content item by a search engine;
determining, from the activity log, at least one keyword in a search query that resulted in location of the content item; and
tagging the content item with a tag associated with the at least one keyword.

2. The method of claim 1, wherein the searchable digital document environment is implemented over a network, and wherein the location of the document results from a user navigating to the document.

3. The method of claim 1, wherein said determining step comprises determining a relative score for content items in a set with respect to specified keywords, and wherein said tagging step comprises tagging the content items having a predetermined score range.

4. The method of claim 3, wherein said score is a percentile rank.

5. The method of claim 1, wherein the content item is a document.

6. The method of claim 1, wherein the content item is a web page that describes streamable video content.

7. The method of claim 1, wherein the content item is streamable video content.

8. An apparatus for assigning a topic tag content item stored within a searchable digital content item environment, said apparatus comprising:
a host server configured to receive a request for a content item;
a processor configured to:
create an activity log for the content item, said activity log including data indicating search queries resulting in the location of the content item by a search engine;
determine, from the activity log, at least one keyword in a search query that resulted in location of the content item; and
tag the content item with a tag associated with the at least one keyword; and
a data store configured to store the data indicating search queries.

9. The apparatus of claim 8, wherein the searchable digital document environment is implemented over a network, and wherein the location of the document results from a user navigating to the document.

10. The apparatus of claim 8, wherein the processor is further configured to determine a relative score for content items in a set with respect to specified keywords, and wherein said tagging step comprises tagging the content items having a predetermined score range.

11. The apparatus of claim 10, wherein said score is a percentile rank.

12. The apparatus of claim 8, wherein the content item is a document.

13. The apparatus of claim 8, wherein the content item is a web page that describes streamable video content.

14. The apparatus of claim 8, wherein the content item is streamable video content.
